(19) United States
(12) Patent Application Publication
(10) Pub. No.: US 2020/0014881 A1
(43) Pub. Date: Jan. 9, 2020

(54) Television Frame

(71) Applicant: FanTron LLC, Norman, OK (US)

(72) Inventors: Andrew Hailey, Norman, OK (US); Hunter Martin, Choctaw, OK (US)

(73) Assignee: FanTron LLC, Norman, OK (US)

(21) Appl. No.: 16/438,835

(22) Filed: Jun. 12, 2019

Related U.S. Application Data
(60) Provisional application No. 62/693,633, filed on Jul. 3, 2018.

(51) Int. Cl. H04N 5/655; H04N 5/63; F21V 33/00

(52) U.S. Cl. CPC H04N 5/655; F21Y 2115/10; F21V 33/0052; H04N 5/63

(57) ABSTRACT

What is claimed is a frame for a television having a substantially rectangular support frame, the support frame having a first horizontal member, a second horizontal member, a first vertical member, a second vertical member, a substantially rectangular finish frame attached to the support frame, the finish frame having a first horizontal panel, a second horizontal panel, a first vertical panel, a second vertical panel, a first cutout in the first vertical panel, a first light panel positioned in the first cutout, a first graphic panel covering the first light panel; and wherein the first light panel is configured to receive electrical power from a power source in the television.

This application is a non-provisional of U.S. Provisional Application 62/693,633 filed Jul. 3, 2018 the entirety of which is hereby incorporated by reference.

### BACKGROUND OF THE INVENTION

### Field of the Invention

The embodiments of the invention relate to a frame for a television, and more particularly, to an adjustable frame for a flat screen television. Although embodiments of the invention are suitable for a wide scope of applications, it is particularly suitable for displaying advertising in close proximity to a television.

### Discussion of the Related Art

The related art television frames include, generally, those of the type disclosed in U.S. Pat. No. 7,808,563 of Sanchez (“Sanchez”). The Sanchez frame includes a generally rectangular frame that mounts to a front of a flat screen television to provide an aesthetic finish to the television. Sanchez, however, does not contemplate or provide for sizing of the frame and thus requires custom frames to be built. Sanchez further does not contemplate customizable portions of the frame for holding surface ornamentation. The frame of Sanchez is therefore rather static, not customizable, and thus not well suited for mass manufacturing or mass appeal. Thus a need exists for a television frame that is easily adjustable to accommodate a variety of television sizes and further customizable to accommodate user-swappable surface ornamentation.

### SUMMARY OF THE INVENTION

Accordingly, embodiments of the invention are directed to a [title of invention] that substantially obviates one or more of the problems due to limitations and disadvantages of the related art.

An object of embodiments of the invention is to provide an adjustable frame for a television.

Another object of embodiments of the invention is to provide a frame for a television having customizable panels,

Additional features and advantages of embodiments of the invention will be set forth in the description which follows, and in part will be apparent from the description, or may be learned by practice of embodiments of the invention. The objectives and other advantages of the embodiments of the invention will be realized and attained by the structure particularly pointed out in the written description and claims hereof as well as the appended drawings.

To achieve these and other advantages and in accordance with the purpose of embodiments of the invention, as embodied and broadly described, television frame includes a substantially rectangular support frame and a substantially rectangular finish frame attached thereto. The support frame has a first horizontal member, a second horizontal member, a first vertical member, and a second vertical member. The finish frame has a first horizontal panel, a second horizontal panel, a first vertical panel, and a second vertical panel. There is a first cutout in the first vertical panel, a first light panel positioned in the first cutout, and a first graphic panel covering the first light panel. The first light panel can be configured to receive electrical power from a power source in the television. The television frame can further include a second cutout in the second vertical panel, a second light panel positioned in the second cutout, and a second graphic panel covering the second light panel. The television frame can still further include a first rail of the first horizontal member and a second rail of the first horizontal member such that the second rail is configured to be slidably retained in the first rail to adjust the length of the first horizontal member. The television frame can further include a first rail of the first vertical member and a second rail of the first vertical member such that the second rail is configured to be slidably retained in the first rail to adjust the height of the first vertical member. The frame for a television can have a plurality of brackets connecting he support frame to the finish frame.

It is to be understood that both the foregoing general description and the following detailed description are exemplary and explanatory and are intended to provide further explanation of embodiments of the invention as claimed.

### BRIEF DESCRIPTION OF THE DRAWINGS

The accompanying drawings, which are included to provide a further understanding of embodiments of the invention and are incorporated in and constitute a part of this specification, illustrate embodiments of the invention and together with the description serve to explain the principles of embodiments of the invention.

FIG. 1 is an illustration of a frame for a television according to an exemplary embodiment of the invention;

FIG. 2 is a partially exploded view of a frame for a television according to an exemplary embodiment of the invention;

FIG. 3 is a detailed view of a support frame for a frame for a television according to an exemplary embodiment of the invention;

FIG. 4A and FIG. 4B are illustrations of horizontal members of a support frame for a frame for a television according to exemplary embodiments of the invention; and

FIG. 5A and FIG. 5B are illustrations of vertical members of a support frame for a frame for a television according to exemplary embodiments of the invention.

### DETAILED DESCRIPTION OF THE PREFERRED EMBODIMENTS

Reference will now be made in detail to the preferred embodiments of the invention, examples of which are illustrated in the accompanying drawings. The invention may, however, be embodied in many different forms and should not be construed as being limited to the embodiments set forth herein; rather, these embodiments are provided so that this disclosure will be thorough and complete, and will fully convey the concept of the invention to those skilled in the art. In the drawings, the thicknesses of layers and regions are exaggerated for clarity. Like reference numerals in the drawings denote like elements.

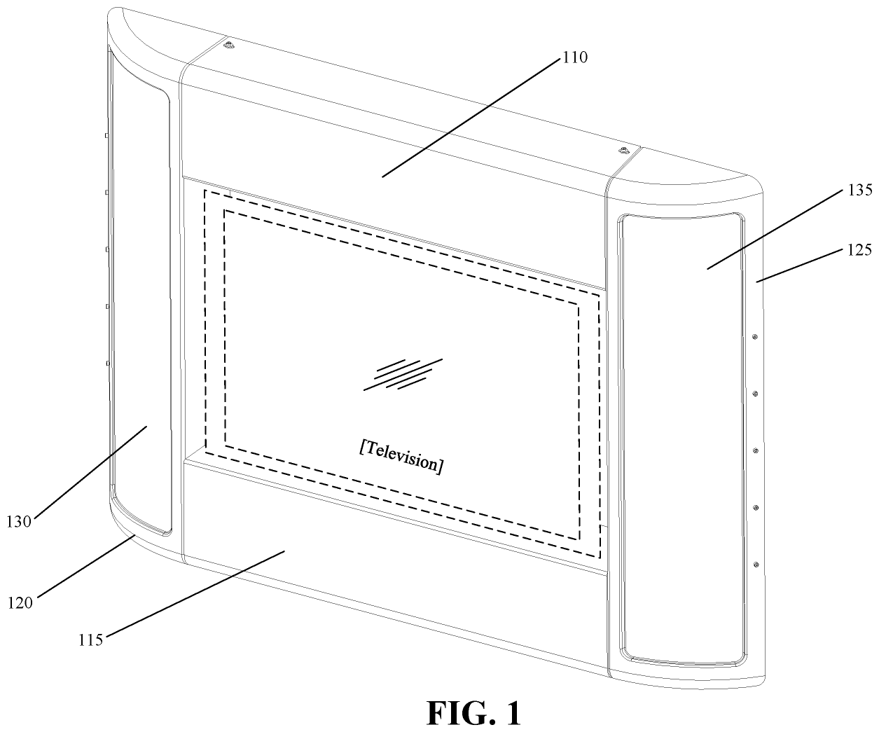

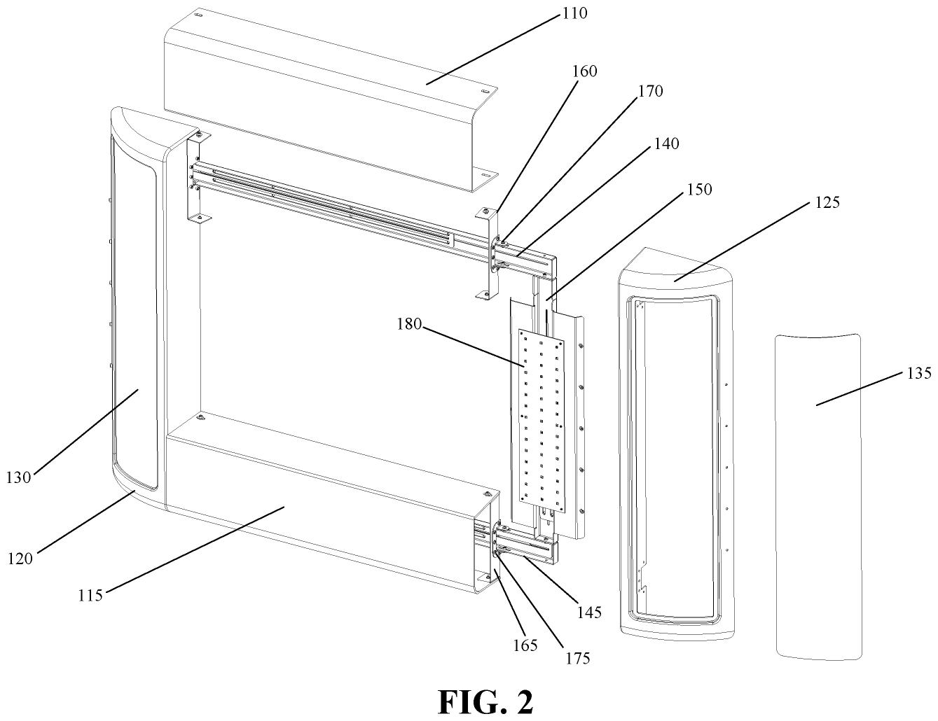

FIG. 1 is an illustration of a frame for a television according to an exemplary embodiment of the invention and FIG. 2 is a partially exploded view of a frame for a television according to an exemplary embodiment of the invention. With reference to FIG. 1 and FIG. 2, a television frame includes generally, a “support frame” and a “finish frame” attached thereto and sized in relative proportions to surround a television.

The finish frame includes horizontal panels 110 and 115, vertical panels 120 and 125, and graphic panels 130 and 135. The support frame includes horizontal frame members 140 and 145 and vertical frame member 150. Brackets 160, 165, 170, and 175 can secure the panels 110, 115, 120, and 125 of the finish frame to the support frame. Light panel 180 can be fixed to vertical frame member 150 and positioned such that light emitted therefrom shines through graphic panel 125.

In preferred embodiments of the invention horizontal frame members 140 and 145 are identical or symmetrical. The support frame can include a second vertical frame member (not shown) under the vertical panel 125 having a substantially similar or symmetrical configuration to vertical frame member 150. The members of the support frame can be interconnected with threaded fasteners. The members of the support frame are preferably formed from stamped sheet metal that is folded in the configuration shown in the figures.

The light panel 180 can include LEDs and a driver circuit (not shown). The light panel 180 can receive electrical power from an auxiliary power port on a television such as a USB port of the television.

Brackets 160 and 170 can form a pair and connect horizontal frame member 140 to horizontal panel 110. Brackets 165 and 175 can connect horizontal frame member 145 to horizontal panel 115. Although brackets in the embodiments have been shown and described as two parts, those of skill in the art will appreciate that other configurations of brackets are contemplated and within the scope of this invention including brackets formed from a single piece of material. Vertical panels 120 and 125 and can connect to vertical frame members (e.g. 150).

In use, support frame members can be attached to a wall around a television and the finish frame members can then be attached thereto via brackets so that the finish frame surrounds the television. Finish frame and, in particular graphic panels 130 and 135, can be customized with designs and drawings according to user preference. In one embodiment, graphic panels 130 and 135 can include team logos. In this way, fans of a particular sports team can proudly display their team affiliations. In another embodiment, graphic panels 130 and 135 include advertising. In this way, bars and restaurants can advertise or promote specials to those watching the television. Light panel 180 behind graphic panel 135 can illuminate and draw attention to the graphic panel 135. A second light panel (not shown) can be disposed behind graphic panel 130.

In mass manufacturing frame members can be adjustable in length and thus one set of frame members can accommodate televisions of a wide range of sizes. It is not critical that the finish panels tightly surround a television. Accordingly, finish panels such as panels 110, 115, 120, 125, 130, and 135 can be bundled to accommodate a range of television sizes such as 40-50″ televisions, 50″-60″ televisions, 60″-70″ televisions, etc. At the retail level, a user may purchase an adjustable support frame, separately purchase a set of finish panels in approximate proportions to the size of the corresponding television, and then separately purchase graphic panels having team logos or insignias according to preference. In commercial embodiments a frame for a television can be shaped in approximate proportions to surround a television (not shown) and have graphics panels that are imprinted with team insignias and logos.

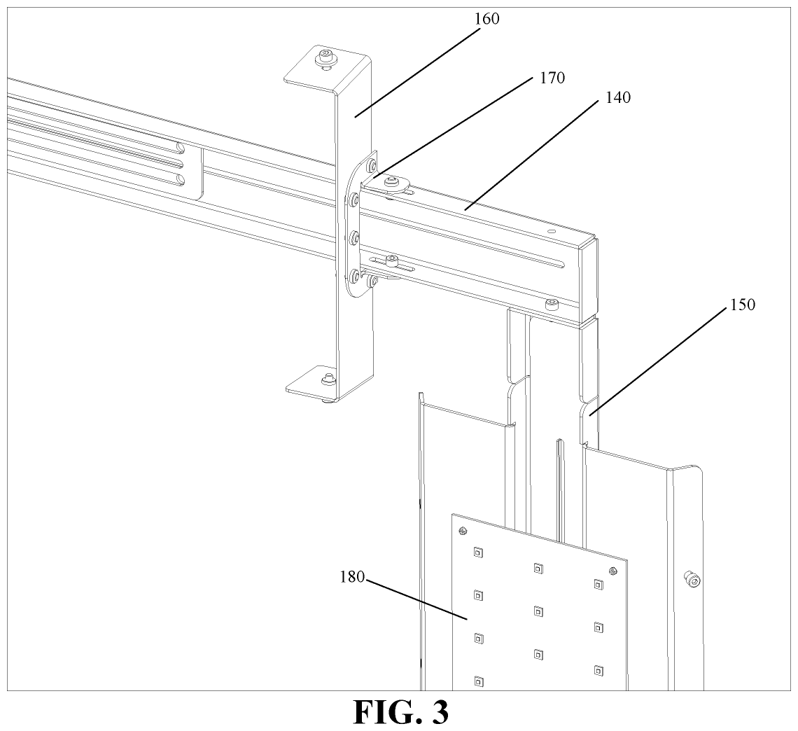

FIG. 3 is a detailed view of a support frame for a frame for a television according to an exemplary embodiment of the invention. As shown in FIG. 3, a support frame includes a horizontal frame member 140, a vertical frame member 150, brackets 160 and 170, and light panel 180. The horizontal frame member 140 can be connected to the vertical frame member 150 via a screw or a bolt. Bracket 170 can be connected to horizontal frame member 140 via screws or bolts. Holes in the horizontal frame member 140 can be over-sized or oblong to allow precise positioning of the bracket 170 with respect to the horizontal frame member 140. Bracket 160 can be connected to bracket 170 with screws or bolts. Bracket 160 can be positioned to retain a finish panel (not shown).

Vertical frame member 150 can include light panel 180. Light panel 180 can be powered by batteries or an external power supply. An external power supply can be, for example, a standard electrical outlet and an AC/DC converter. An external power supply can also be, for example, a USB port on a television.

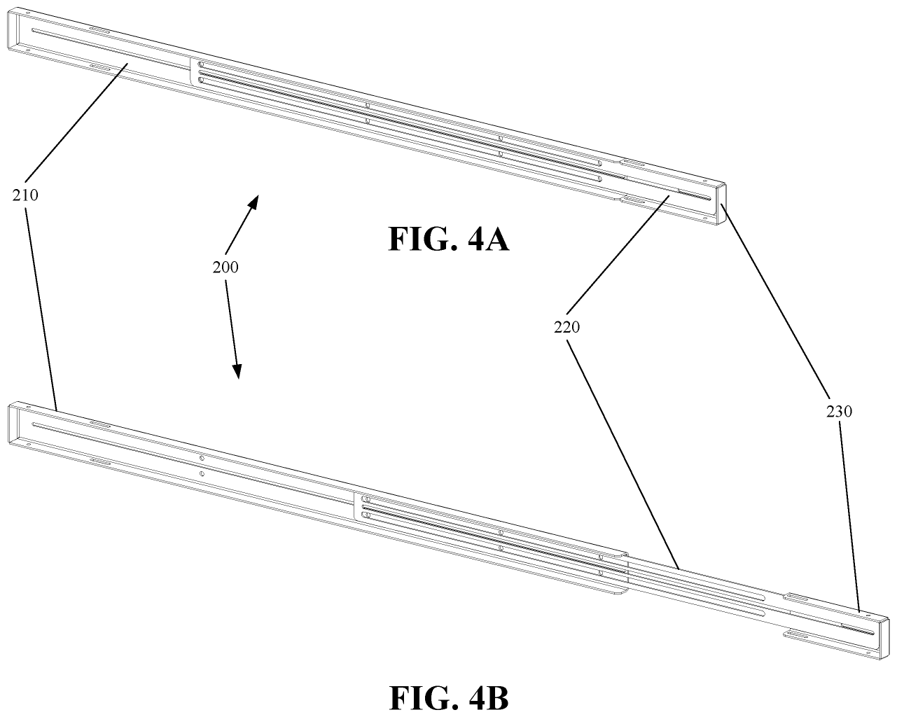

FIG. 4A and FIG. 4B are illustrations of horizontal members of a support frame for a frame for a television according to exemplary embodiments of the invention. As shown in FIG. 4A and FIG. 4B, a horizontal member 200 of a support frame can be formed from substantially three pieces: a first side 210, a connector piece 220, and a second side 230. The connector piece 220 can be semi permanently fixed to the second side 230. The connector piece 220 can be slidably disposed in the first side so that it can be repositioned to make the horizontal member 200 longer or shorter thereby accommodating televisions of varying sizes. The first side 210, connector piece 220, and second side 230 can have varying holes and slots to allow ample opportunities for fasteners to attach the horizontal member 200 to a wall while ensuring proper anchoring in a stud.

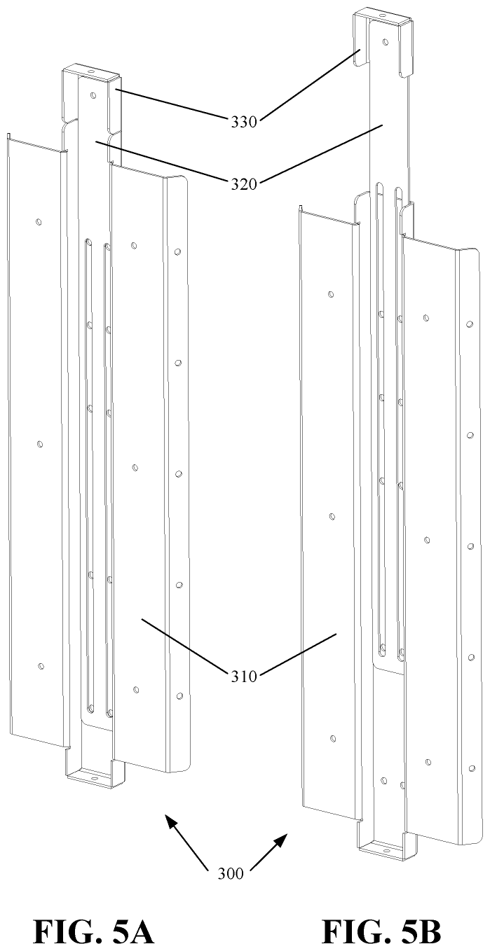

FIG. 5A and FIG. 5B are illustrations of vertical members of a support frame for a frame for a television according to exemplary embodiments of the invention. As shown in FIG. 5A and FIG. 5B, a vertical member 300 of a support frame can be formed from substantially three pieces: a first side 310, a connector piece 320, and a second side 330. The connector piece 320 can be semi permanently fixed to the second side 330. The connector piece 320 can be slidably disposed in the first side so that it can be repositioned to make the vertical member 200 taller or shorter thereby accommodating televisions of varying sizes. The first side 310, connector piece 320, and second side 330 can have varying holes and slots to allow ample opportunities for fasteners to attach the vertical member 300 to a wall while ensuring proper anchoring in a stud.

It will be apparent to those skilled in the art that various modifications and variations can be made in the television frame without departing from the spirit or scope of the invention. Thus, it is intended that embodiments of the invention cover the modifications and variations of this invention provided they come within the scope of the appended claims and their equivalents.

What is claimed is:

1. A frame for a television comprising:
a substantially rectangular support frame having
a first horizontal member;
a second horizontal member;
a first vertical member;
a second vertical member;
a substantially rectangular finish frame attached to the support frame, the finish frame having
a first horizontal panel;
a second horizontal panel;
a first vertical panel;
a second vertical panel;
a first cutout in the first vertical panel;
a first light panel positioned in the first cutout;
a first graphic panel covering the first light panel; and
wherein the first light panel is configured to receive electrical power from a power source in the television.

2. The frame for a television of claim 1 further comprising:
a second cutout in the second vertical panel;
a second light panel positioned in the second cutout;
a second graphic panel covering the second light panel;

3. The frame for a television of claim 1 further comprising:
a first rail of the first horizontal member;
a second rail of the first horizontal member; BM-U-032
wherein the second rail is configured to be slidably retained in the first rail to adjust the length of the first horizontal member.

4. The frame for a television of claim 1 further comprising:
a first rail of the first vertical member;
a second rail of the first vertical member;
wherein the second rail is configured to be slidably retained in the first rail to adjust the height of the first vertical member.

5. The frame for a television of claim 1 further comprising a plurality of brackets connecting the support frame to the finish frame.

6. A frame for a television comprising:
a substantially rectangular support frame having
a first horizontal member;
a second horizontal member;
a first vertical member;
a second vertical member;
a substantially rectangular finish frame attached to the support frame, the finish frame having
a first horizontal panel;
a second horizontal panel;
a first vertical panel;
a second vertical panel;
a first cutout in the first vertical panel;
a first light panel positioned in the first cutout;
a first graphic panel covering the first light panel;
wherein the first light panel is configured to receive electrical power from a power source in the television;
a second cutout in the second vertical panel;
a second light panel positioned in the second cutout;
a second graphic panel covering the second light panel;
a first rail of the first horizontal member;
a second rail of the first horizontal member;
wherein the second rail is configured to be slidably retained in the first rail to adjust the length of the first horizontal member;
a first rail of the first vertical member;
a second rail of the first vertical member;
wherein the second rail is configured to be slidably retained in the first rail to adjust the height of the first vertical member; and
a plurality of brackets connecting the support frame to the finish frame.
